(19) United States
(12) Patent Application Publication
(10) Pub. No.: US 2018/0232205 A1
(43) Pub. Date: Aug. 16, 2018

(54) APPARATUS AND METHOD FOR RECURSIVE PROCESSING

(71) Applicant: FUJITSU LIMITED, Kawasaki-shi (JP)

(72) Inventor: Keisuke GOTO, Kawasaki (JP)

(73) Assignee: FUJITSU LIMITED, Kawasaki-shi (JP)

(21) Appl. No.: 15/877,144

(22) Filed: Jan. 22, 2018

(30) Foreign Application Priority Data
Feb. 14, 2017 (JP) 2017-025400

(51) Int. Cl. G06F 7/08; G06F 7/483; G06F 17/30; G06F 7/556

(52) U.S. Cl. CPC G06F 7/08; G06F 7/556; G06F 17/30513; G06F 7/4833

(57) ABSTRACT

An apparatus for recursive processing includes: a memory and a processor configured to in a first step of a plurality of steps in which a specific process is executed, execute a determination process of whether a size of first data to be processed in the first step coincides with a first upper size limit defined based on a state of a second step of the plurality of steps, store a result of the determination process in the memory, and in a third step of the plurality of steps, identify the size of the first data with reference to the result stored in the memory, and execute the specific process of the third step based on the identified size of the first data.

### CROSS-REFERENCE TO RELATED APPLICATION

This application is based upon and claims the benefit of priority of the prior Japanese Patent Application No. 2017-25400, filed, on Feb. 14, 2017, the entire contents of which are incorporated herein by reference.

### FIELD

The embodiments discussed herein are related of a technique for recursive processing.

### BACKGROUND

To solve a certain problem in using a result of a small problem corresponding to part of the problem, a recursive process is used, FIG. 1 illustrates a recursive process. In FIG. 1, a rectangle represents a problem. In solving a problem in a step i (i is an integer of zero or more), a process of a step (i+1) is recursively called. Then, after a problem of the step (i+1) is solved, the problem of the step i may be solved by using a result of the step (i+1).

For example, in a recursive process executed in the case where a suffix array is generated, in solving a problem of a certain step, information of a problem size of a previous step is used. For this reason, in addition to a storage space that stores a problem instance of each step, a storage space that stores information of a problem size of each step is prepared,

Thus, in the case where a certain type of recursive process is executed, an additional storage space is used. In the case of a system (for example, an embedded system) in which a particularly limited storage space is usable, the occupation of the storage space may affect the performance of a process other than the recursive process.

A related technique is disclosed in Japanese Laid-open Patent Publication No. 1-142959, for example.

### SUMMARY

According to an aspect of the invention, an apparatus for recursive processing includes: a memory and a processor configured to: in a first step of a plurality of steps in which a specific process is executed, execute a determination process of whether a size of first data to be processed in the first step coincides with a first upper size limit defined based on a state of a second step of the plurality of steps, store a result of the determination process in the memory, and in a third step of the plurality of steps, identify the size of the first data with reference to the result stored in the memory, and execute the specific process of the third step based on the identified size of the first data,

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a recursive process;

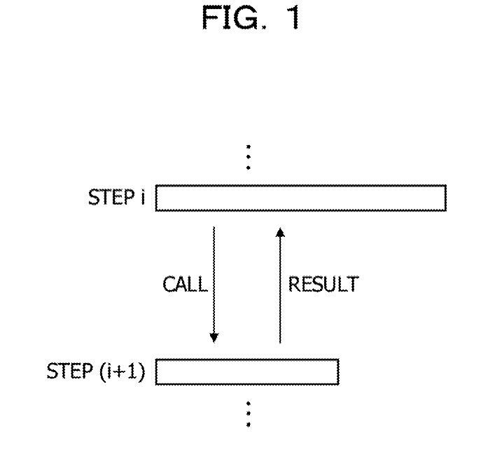

FIG. 2 illustrates a recursive process executed in generating a suffix array;

FIG. 3 illustrates the recursive prose executed in generating the suffix array;

FIG. 4 illustrates a first method considered as a method for storing information of a problem size;

FIG. 5 illustrates a second method considered as a method for storing information of a problem size;

FIG. 6 is a functional block diagram of information processing apparatus;

FIG. 7 illustrates a process flow of a process of storing information used for reconstructing information of a problem size;

FIG. 8 illustrates a process flow of a process of reconstructing information of a problem size;

FIG. 9 specifically illustrates transitions of a work space and a management space;

FIG. 10 specifically illustrates transitions of the work space and the management space;

FIG. 11 specifically illustrates transitions of the work space and the management space;

FIG. 12 specifically illustrates transitions of the work space and the management space;

FIG. 13 specifically illustrates transitions of the work space and the management space;

FIG. 14 specifically illustrates transitions of the work space and the management space;

FIG. 15 specifically illustrates transitions of the work space and the management space; and

FIG. 16 is a functional block diagram of a computer.

### DESCRIPTION OF EMBODIMENTS

First Embodiment

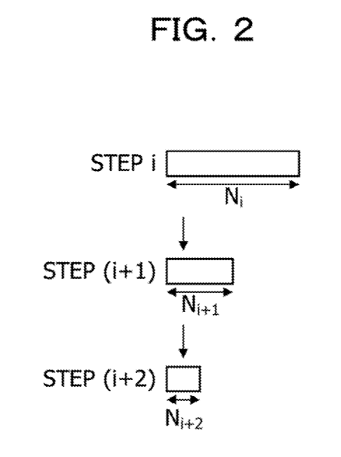

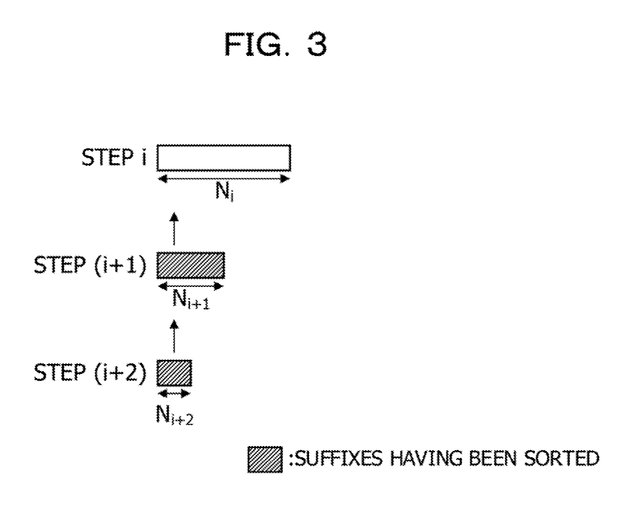

A suffix array is an array obtained by sorting all suffixes of a character string in dictionary order. Taking, as an example, a recursive process executed in generating a suffix array, this embodiment will be described below. First, a recursive process executed in generating a suffix array will be simply described with reference to FIGS. 2 and 3. In FIGS. 2 and 3, rectangles represent sizes of data to be processed in respective steps (that is, sizes of problem instances, which are each hereinafter referred to as a problem size). Nᵢ denotes a problem size of a step i.

In generating a suffix array, in each step, suffixes that are not more than half of target suffixes (that is, 1/c suffixes (c is an integer satisfying the relationship of 1<c≤N), and N represents an initial problem size) are recursively sorted. Thus, suffixes of a step (i+1) correspond to suffixes that are not more than half of suffixes of the step i, and suffixes of a step (i+2) correspond to suffixes that are not more than half of the suffixes of the step (i+1). In the following description, the value of c is 2, that is, c=2, unless otherwise specified.

In each step, target suffixes are sorted by using suffixes sorted in a subsequent step. Specifically, in the step (i+1), target suffixes are sorted by using suffixes sorted in the step (i+2). In the step i, target suffixes are sorted by using the suffixes sorted in the step (i+1). Here, in each step, a problem size (for example, the number of suffixes) of a previous step is used for sorting. Specifically, in the step (i+2), a problem size of the step (i+1) is used for sorting. In the step (i+1), a problem size of the step i is used for sorting.

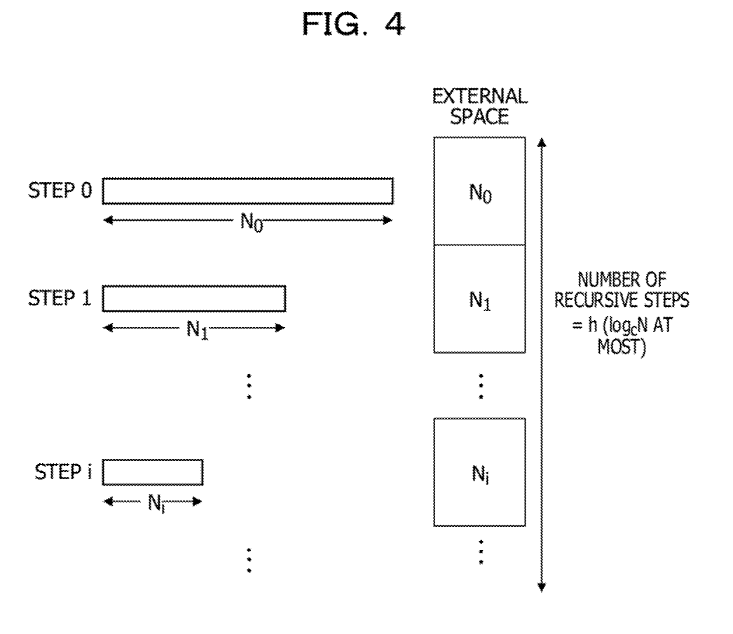

A first method considered as a method for storing information of a problem size will be described with reference to FIG. 4. In the first method, in addition to a work space, an external space (for example, a stack space) is prepared, and a problem size is stored in the external space. In this case, the time it takes to acquire data is O(1) time in O notation, and a space is O(log N)+log N² bits in O notation. Here, h denotes the number of steps. In the following description, if the base of a logarithm is missing, the base is 2.

The first method enables high-speed processing, but results in an increase in the size of a space used.

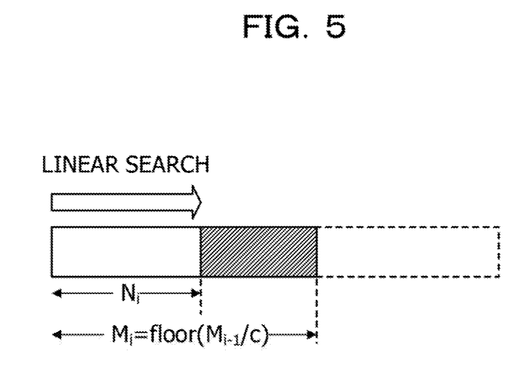

A second method considered as a method for storing information of a problem size will be described with reference to FIG. 5. In the second method, information representing an unused state is written into a work space not used, and a linear search is performed from the top of a work space used to thereby calculate N. FIG. 5 illustrates a work space of the step i, and Mᵢ,(=floor(Mᵢ₋₁/c)) is an upper limit of a problem, size. Here, floor is a round-down function. A hatched portion represents the work space not used. In this case, the time it takes to acquire data is O(N) time in O notation, and a space is O(log N) bits in O notation.

The second method enables a reduction in the size of a space used, but results in low-speed processing.

As described above, the two method described above result in low-speed processing or an increase in the size of a space used. Thus, in this embodiment, the following method to be described reduces the size of a storage space used while maintaining the performance of a recursive process.

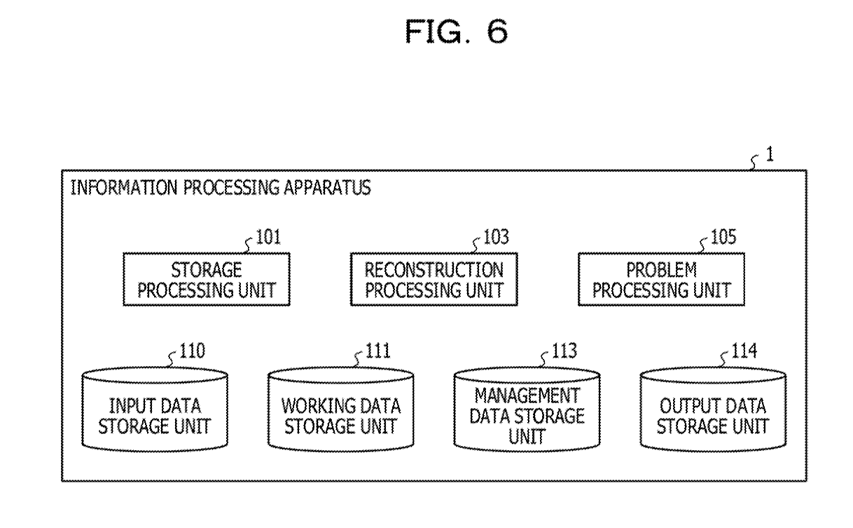

FIG. 6 is a functional block diagram of an information processing apparatus 1 according to this embodiment. The information processing apparatus 1 includes a storage processing unit 101, a reconstruction processing unit 103, a problem processing unit 105, an input data storage unit 110, a working data storage unit 111, a management data storage unit 113, and an output data storage unit 114.

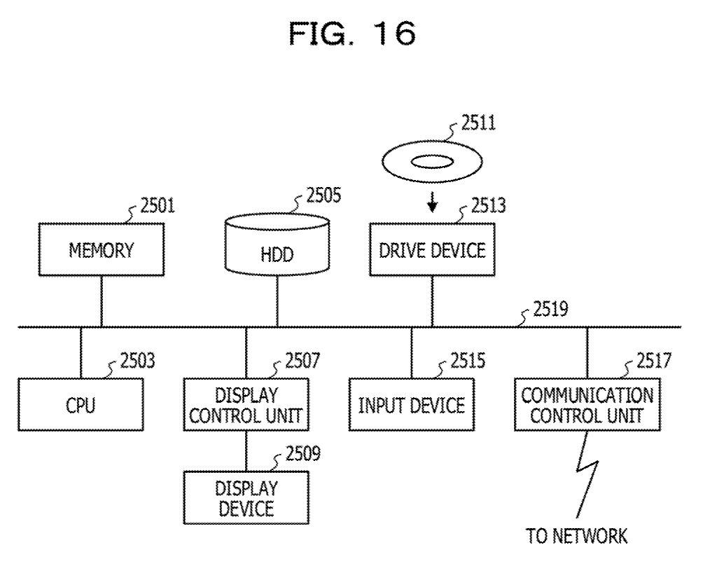

The storage processing unit 101, the reconstruction processing unit 103, and the problem processing unit 105 are implemented by a central processing unit (CPU) 2503 executing a program loaded into memory 2501 illustrated in FIG. 16e. The working data storage unit 111 and the management data storage unit 113 are provided in, for example, the memory 2501 illustrated in FIG. 16. The input data storage unit 110 and the output data storage unit 114 are provided in, for example, the memory 2501 or a hard disk drive (HDD) 2505 illustrated in FIG. 16.

The storage processing unit 101 generates, based on data stored in the input data storage unit 110, information used for reconstructing information of a problem size and stores the information in the management data storage unit 113. The reconstruction processing unit 103 reconstructs the information of the problem size by using the information stored in the management data storage unit 113 by the storage processing unit 101. The problem processing unit 105 executes a suffix array generation process (including a recursive process) by using the information of the problem size reconstructed by the reconstruction processing unit 103 and stores an execution result in the output data storage unit 114,

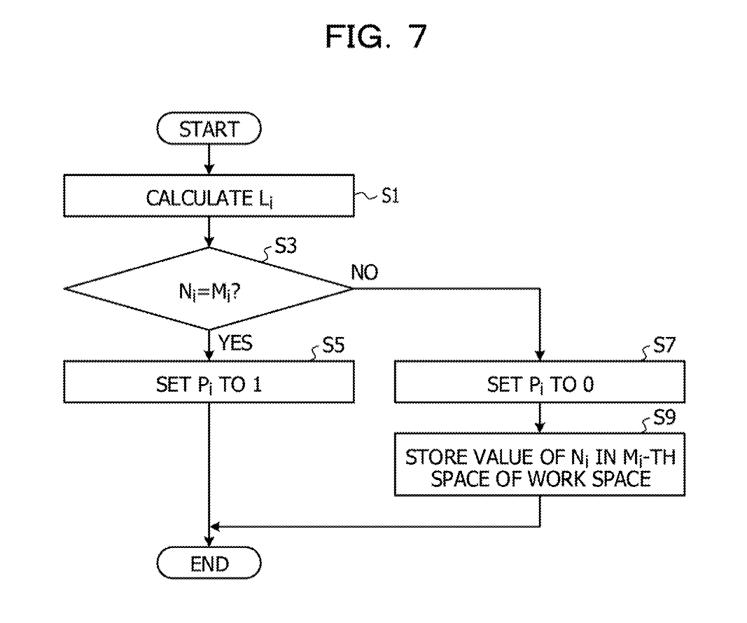

Next, a process of storing information used for reconstructing information of a problem size will be described with reference to FIG. 7. Although the process is executed for each step, for the sake of simplicity, the case where the process is executed for the step i will be described.

First, the storage processing unit 101 calculates in accordance with Lᵢ=Mᵢ, mod c (step S1 in FIG. 7). The storage processing unit 101 stores the calculated in the management data storage unit 113.

Note that c has been stored in the input data storage unit 110. Mᵢ is calculated in accordance with Mᵢ=floor (Mᵢ₋₁/c), and M₀=N₀=N holds. M₀, N₀, and N have been stored in the input data storage unit 110. Note that M₁ is a maximum size of a continuous space usable in the step i (that is, an upper limit of a problem size).

The storage processing unit 101 determines whether Nᵢ=Mᵢ, holds (step S3). When Nᵢ=Mᵢ holds (Yes route in step S3), the storage processing unit 101 sets Pᵢ to 1 (step S5). Then, the storage processing unit 101 stores Pᵢ (that is, 1) in the management data storage unit 113.

On the other hand, when Nᵢ=Mᵢ, does not hold (No route in step S3), the storage processing unit 101 sets Pᵢ to 0 (step S7). Then, the storage processing unit 101 stores Pᵢ (that is, 0) in the management data storage unit 113. Furthermore, the storage processing unit 101 stores Nᵢ in an Mᵢ-th space of a work space (that is, a space of the working data storage unit 111) of the step i (step S9). Nᵢ, has been identified when a call is made from a step (i-1). Then, the process ends.

The work space of the step i includes an Mᵢ number of spaces, and thus Nᵢ is stored in the Mᵢ-th space of the Mᵢ number of spaces in step S9. The Mᵢ-th space is a space corresponding to a difference between Nᵢ, and Mᵢ. This will be described later using a specific example.

As described above, in this embodiment, information of a problem size is not directly stored. Minimum information (that is, Pᵢ and Lᵢ ) used for reconstructing the information of the problem size is stored. Although, when Nᵢ ≠Mᵢ holds, the information of the problem size is stored, a space in which the information of the problem size is stored is part of the work space, and thus an additional space does not have to be prepared for storing the information of the problem size.

As a specific example is given later, Lᵢ and Pᵢ are stored for each step, but Mᵢ and Nᵢ are stored only for a final step.

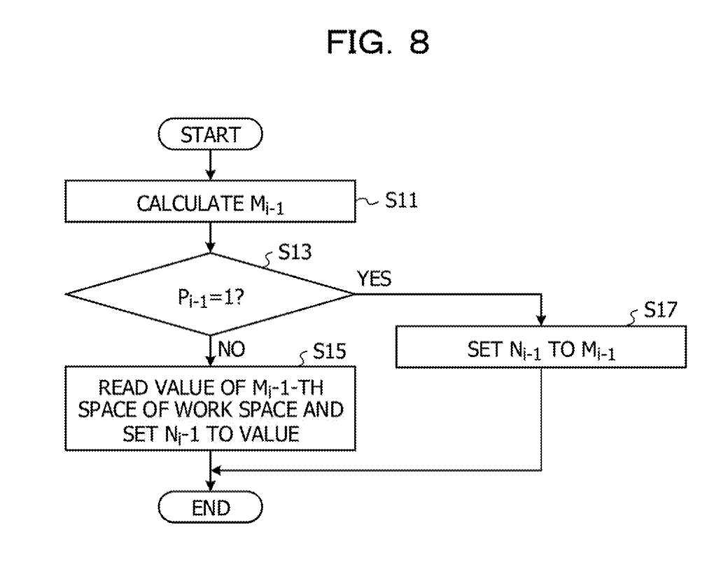

Next, a process of reconstructing information of a problem size will be described with reference to FIG. 8. Although the process is executed for each step, for the sake of simplicity, the case where the process is executed for the step i will be, described.

First, the reconstruction processing unit 103 reads Mᵢ and Lᵢ₋₁ from the management data storage unit 113 and calculates Mᵢ₋₁ in accordance with Mᵢ₋₁=ceil(c*Mᵢ)+Lᵢ₋₁ (step S11 in FIG. 8), Here, cell is a round-up function,

The reconstruction processing unit 103 reads Pᵢ₋₁ from the management data storage unit 113 and determines whether Pᵢ₋₁=1 (that is, Mᵢ₋₁=Nᵢ₋₁) holds (step S13).

When Pᵢ₋₁=1 holds (Yes route in step S13), the reconstruction processing unit 103 sets Nᵢ₋₁ to Mᵢ₋₁ (step S17). Then, the problem processing unit 105 executes a process for a problem of the step i by using Nᵢ₋₁ reconstructed by the reconstruction processing unit 103.

On the other hand, when Pᵢ₋₁32 1 does not hold (No route in step S13), the reconstruction processing unit 103 reads a value of an Mᵢ₋₁-th space of a work space of the step (i−1) from the working data storage unit 111. Then, the reconstruction processing unit 103 sets Nᵢ₋₁ to the read value (step S15). Then, the problem processing unit 105 executes a process for a problem of the step i by using Nᵢ₋₁ reconstructed by the reconstruction processing unit 103. Then, the process ends.

A final execution result (that is, a suffix array) is stored in the output data storage unit 114.

As described above, in this embodiment, processing may be executed in each step without storing information itself of a problem size. Thus, in the case where a particularly limited storage space is usable, or in the case where a recursive process is executed on large amounts of data, the number of resources may be reduced, thus enabling cost reduction. Furthermore, a higher processing speed and the omission of unnecessary processing enable an improvement in real-time performance and low power consumption.

In the method according to this embodiment, information used is Mᵢ, Pᵢ, and Lᵢ, and thus the time it takes to acquire data is O(1) time in O notation. Also, Pᵢ=1 bit holds, Lᵢ=log 2=1 bit holds, and thus a space is O(log N)+(1+1)*h=O(log N)+2 log N bits in O notation. In comparison with the first method described with reference to FIG. 4, the time is equal, and the space may be reduced from 4096 bits to 128 bits. Also, in comparison with the second method described with reference to FIG. 5 processing may be speeded up 2⁶⁴ times by adding a 128-bit space.

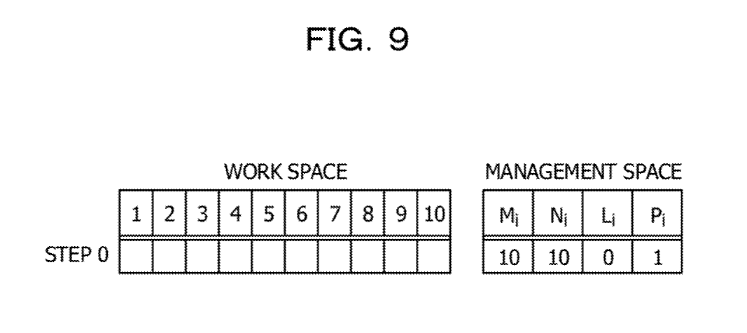

State transitions of a work space and a management space (here, space of the management data storage unit 113) in this embodiment will be specifically described with reference to FIGS. 9 to 15.

FIG. 9 illustrates an initial state. That is, a work space is divided into 10 spaces, and, in a management space, M₀=10 and N₀=10 have been stored as initial values. Furthermore, because of M₀=N₀, P₀=1 has been stored, and L₀=M₀ mod 2=0 has been stored. Note that N is 10 and c is 2.

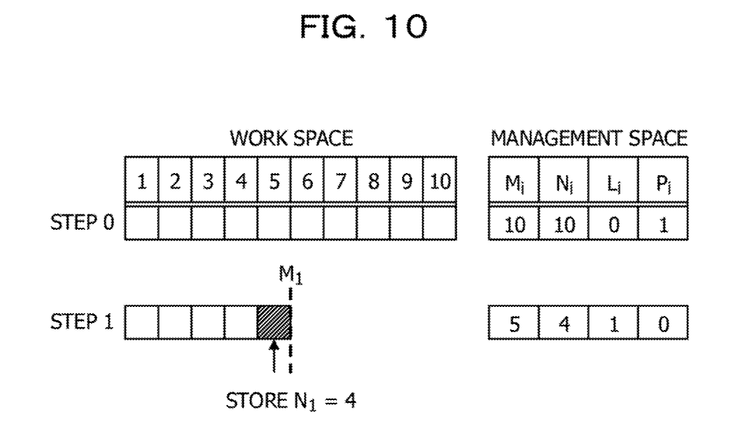

As illustrated in FIG. 10, in a step 1, M₁ and L₁ are calculated. M₁=floor(M₀/2)=5 holds, and L₁=M₁ mod 2=1 holds. N₁ has been identified as 4. Because of M₁≠N₁, P₁ is 0. Thus, N₁=4 is stored in an M₁(=5)-th space of a work space of the step 1.

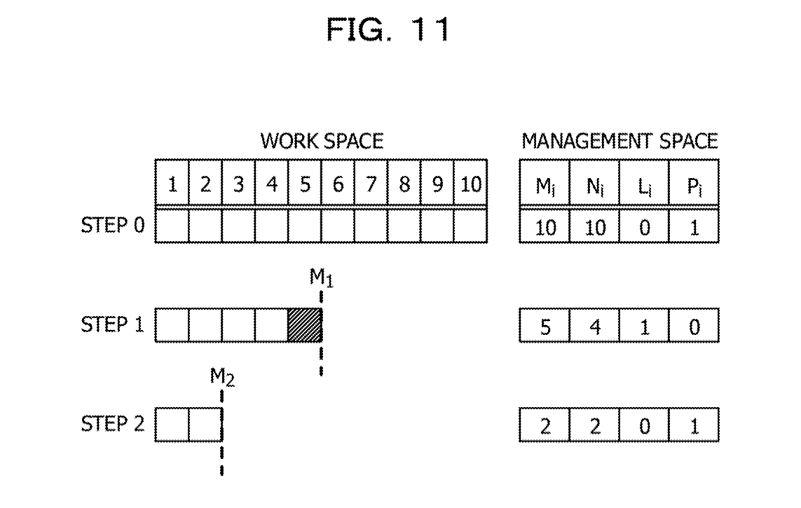

As illustrated in FIG. 11, in a step 2, M₂ and L₂ are calculated. M₂=floor(M₁/2)=2 holds, and L₂=M₂ mod 2=0 holds. N₂ has been identified as 2. Because, of M₂=N₂, P₂ is 1.

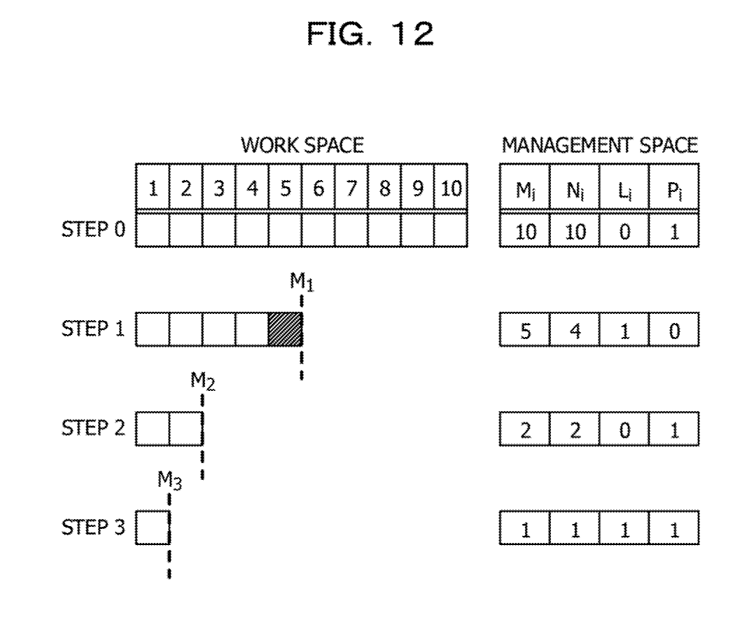

As illustrated in FIG. 12, in a step 3, M₃ and L₃ are calculated. M₃=floor(M₂/2)=1 holds, and L₃=M₃ mod 2=1 holds. N₃ has been identified as 1. Because of M₃=N₃, P₃ is 1.

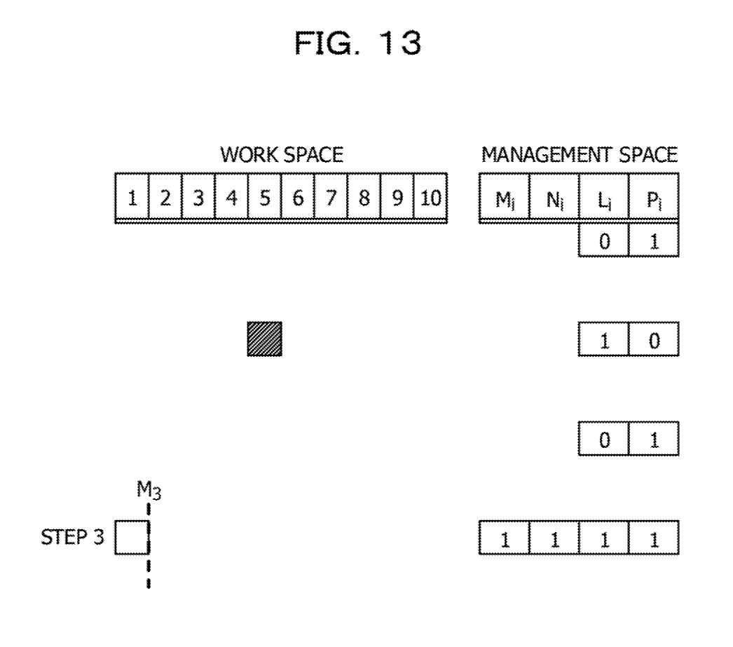

In this example, assume that the step 3 is a final step. In this case, as illustrated in FIG. 13, except for the M₁-th space of the work space of the step 1, work spaces of steps 0 to 2 are freed up (that is, data is not explicitly stored). Furthermore, spaces of Mᵢ, and Nᵢ of management spaces of the steps 0 to 2 are freed up (that is, data is not explicitly stored).

Then, a problem size of the step 2-is reconstructed based on a state illustrated in FIG. 13. M₂=ceil(c*M₃)+L₂=ceil(2*1)+0=2 holds. Because of P₂=1, N₂=M₂=2 holds.

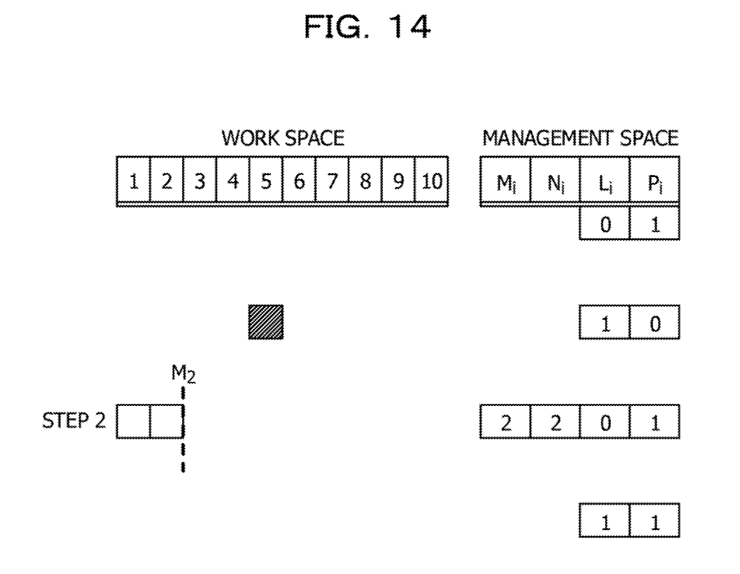

Then, a problem size of the step 1 is reconstructed based on a state illustrated in FIG. 14. M₁=ceil(c*M₂)+L₁=ceil(2*2)+1±5 holds. Because of P₁=0, N₁ is read from the M₁-th space of the work space of the step 1. Thus, N₁=4 holds.

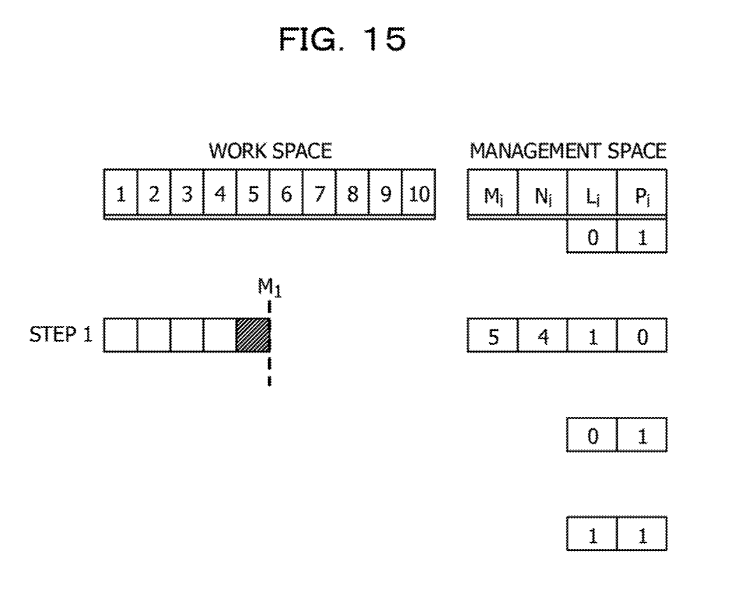

Then, a problem size of the step 0 is reconstructed based on a state illustrated in FIG. 15. M₀=ceil(c*M₁)+L₀=ceil(2*5)+0=10 holds. Because of P₀=1, N₀=M₀=10 holds.

When the above-described processing is executed, information of a problem size of a previous step may be identified. As illustrated in FIGS. 14 and 15, Mᵢ and Nᵢ of a step previous to a target step are reconstructed, and, when a process of the target step using the reconstructed Nᵢ has completed, spaces of Mᵢ and Nᵢ and a work space of the target step may be freed up.

Second Embodiment

The method according to the first embodiment is provided for the case where a problem size of the step (i+1) is 1/c times a problem size of the step i. On the other hand, a method according to the second embodiment is provided for the case where a problem size of the step (i±1) is smaller than a problem size of the step i by c.

In this case, the method according to the first embodiment may be changed as described below,

First, definitions are changed as follows.

(1) c≥1

(2) Mᵢ₊₁=floor(Mᵢ−c)

(3) h=o(N)

(4) Lᵢ=Mᵢ−ceil(c+Mᵢ₊₁)

Furthermore, when Mᵢ has been identified in the step i, calculations for obtaining Mᵢ₋₁ and Nᵢ₋₁ are changed as follows.

(1) Mᵢ=ceil(c+Mᵢ)+Lᵢ₋₁

(2) for the case of Pᵢ₋=1, Nᵢ₋₁=Mᵢ₋₁

(3) for the case of Pᵢ₋₁≠1, Nᵢ₋₁=a value, stored in the Mᵢ₋₁-th space of the work space of the step (i-1)

When changes are made as described above, with respect to the case as well where a problem size of the step (i+1) is smaller than a problem size of the step i by c, processing may be speeded up, and an increase in the size of a storage space may be inhibited.

Although the embodiments have been described above, the present, disclosure is not limited to these embodiments. For example, in some cases, the functional block configuration of the information processing apparatus 1 described above does not coincide with an actual program module configuration,

Furthermore, the data configuration described above is merely an example, and a data configuration does not have to be such a configuration.

With respect to each process flow, the order in which operations are executed may be rearranged as long as a processing result is the same. Additionally, operations may be executed in parallel.

Furthermore, although a recursive process executed in generating a suffix array has been described as an example the embodiments are applicable to another recursive process. For example, in the case where information before being subjected to a recursive process is used after the recursive process, the processes according to the embodiments are applicable, and thus processes similar to the processes according to the embodiments may be executed for information other than information of a problem size.

Furthermore, the embodiments may be applied to a process that other than a recursive process and in which a specific process is executed repeatedly.

The above-described information processing apparatus 1 is a computer apparatus. As illustrated in FIG. 16, the memory 2501, the CPU 2503, the HDD 2505, a display control unit 2507 connected to a display device 2509, a drive device 2513 for a removable disk 2511, an input device 2515, and a communication control unit 2517 for connection to a network are connected to one another with a bus 2519. An operating system (OS) and an application program for implementing the processes according to the embodiments are stored in the HDD 2505 and read from the HDD 2505 into the memory 2501 when executed by the CPU 2503. The CPU 2503 controls the display control unit 2507, the communication control unit 2517, and the drive device 2513 in accordance with processing details of the application program to cause them to perform certain operations. Furthermore, although data being processed is mostly stored in the memory 2501, the data being processed may also be stored in the HDD 2505. In the embodiments, the application program for implementing the above-described processes is stored in the removable disk 2511 that is computer-readable, is distributed, and is installed on the HDD 2505 via the drive device 2513. In some cases, the application program is installed on the HDD 2505 via a network, such as the Internet, and the communication control unit 2517 Such a computer apparatus implements the various functions described above by organic cooperation between hardware, such as the CPU 2503 and the memory 2501 described above, and programs, such as the OS and the application program.

The above-described embodiments are summarized as follows.

A storage method according to a first aspect of the embodiments includes (A), in a first step of a plurality of steps in which a specific process is executed, determining whether a problem size that is a size to be processed in the first step coincides with an upper size limit defined based on a state of a step previous to the first step; (B) storing a determination result in a storage space; and (C), in a second step that is a step subsequent to the first step, identifying the problem size by using the determination result stored in the storage space, and executing the specific process of the second step based on the identified problem size.

This makes it possible to inhibit an increase in the storage space that stores information of a problem size of a previous step. Thus, in the case where the specific process is executed repeatedly, an increase in the size of the storage space used during the execution is inhibited.

The storage method may further include (D), in the first step, storing information of a remainder obtained by dividing the upper size limit by a certain number in the storage space. Then, in the executing the specific process of the second step, (c1), when the determination result represents that the problem size coincides with the upper size limit, the problem size may be identified by using the information of the remainder stored in the storage space,

This makes it possible to deal with a problem even when the problem size is not able to be identified only by the determination result.

The storage method may further include (E), when the problem size does not coincide with the upper size limit, in the first step, storing information of the problem size in a space corresponding to a difference between the problem size and the upper size limit. Then, in the executing the specific process of the second step, (c2), when the determination result represents that the problem size does not coincide with the upper size limit, the problem size may be read from the space corresponding to the difference.

The information of the problem size is stored in the space not used, and thus newly used spaces do not increase in number,

In the executing the specific process of the second step, (c3) the problem size may be identified by using a value obtained by multiplying an upper size limit of a size to be processed in the second step by the certain number, and the information of the remainder.

A storage apparatus according to a second aspect of the embodiments includes (F) a storing processing unit (for example, the storage processing unit 101) configured to, in a first step of a plurality of steps in which a specific process is executed, determine whether a problem size that is a size to be processed in the first step coincides with an upper size limit defined based on a state of a step previous to the first step, and store a determination result in a storage space (for example, a space of the management data storage unit 113); and (G) an execution unit (for example, the reconstruction processing unit 103) configured to, in a second step that is a step subsequent to the first step, identify the problem size by using the determination result stored in the storage space, and execute the specific process of the second step based on the identified problem size.

A program for causing a processor to execute processing according to the above-described method may be created. The program is stored in computer-readable storage media or storage devices, such as a flexible disk, a compact disc read only memory (CD-ROM), a magnetic optical disk, a semiconductor memory, and a hard disk. An intermediate processing result is temporarily stored in a storage device, such as main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made, hereto without departing from the spirit and scope of the invention.

What is claimed is:

1. An apparatus for recursive processing comprising;
a memory; and
a processor coupled to the memory and the processor configured to:
in a first step of a plurality of steps in which a specific process is executed, execute a determination process of whether a size of first data to be processed in the first step coincides with a first upper size limit defined based on a state of a second step of the plurality of steps,
store a result of the determination process in the memory, and
in a third step of the plurality of steps, identify the size of the first data with reference to the result stored in the memory, and execute the specific process of the third step based on the identified size of the first data

2. The apparatus according to claim 1,
wherein the specific process is executed in order of he third step, the first step, and the second step.

3. The apparatus according to claim 1,
the processor further configured to store information of a remainder obtained by dividing the first upper size limit by a certain number in the memory in association with the result,
wherein, when the result represents that the size of the first data coincides with the first upper size limit, the size of the first data is identified by using the information of the remainder stored in the memory.

4. The apparatus according to claim 3,
wherein, in a process of identifying the size of the first data in the third step, the size of the first data is identified by using a value and the information of the remainder, the value being obtained by multiplying a second upper size limit defined based on a state of the first step by the certain number.

5. The apparatus according to claim 1,
the processor further configured to, when the size of the first data does not coincide with the first upper size limit, in the first step, store information representing the size of the first data in a space corresponding to a difference between the size of the first data and the first upper size limit,
wherein a process of identifying the size of the first data in the third step includes, when the result represents that the size of the first data does not coincide with the first upper size limit, reading the size of the first data from the space corresponding to the difference.

6. A method, executed by a computer, for recursive processing comprising:
in a first step of a plurality of steps which a specific process is executed, executing a determination process of whether a size of first data to be processed in the first step coincides with a first upper size limit defined based on a state of a second step of the plurality of steps;
storing a result of the determination process in a memory; and
in a third step of the plurality of steps, identifying the size of the first data with reference to the result stored in the memory, and executing the specific process of the third step based on the identified size of the first data,

7. The method according to claim 6,
wherein the specific process is executed order of the third step, the first step, and the second step.

8. The method according to claim 6,
the method further comprising storing information of a remainder obtained by dividing the first upper size limit by a certain number in the memory its association with the result,
wherein, when the result represents that the size of the first data coincides with the first upper size limit, the size of the first data is identified by using the information of the remainder stored in the memory,

9. The method according to claim 8,
wherein in a process of identifying the size of the first data in the third step, the size of the first data is identified by using a value and the information of the remainder, the value being obtained by multiplying a second upper size limit defined based on a state of the first step by the certain number.

10. The method according to claim 6,
the method further comprising, when the size of the first data does not coincide with the first upper size limit, in the first step, storing information representing the size of the first data in a space corresponding to a difference between the size of the first data and the first upper size limit,
wherein a process of identifying the size of the first data in the third step includes, when the result represents that the size of the first data does not coincide with the first upper size limit reading the size of the first data from the space corresponding to the difference.

11. A non-transitory compute readable medium storing a program that causes a computer to execute -a process comprising:
in a first step of a plurality of steps in which a specific process is executed, executing a determination process of whether a size of first data to be processed in the first step coincides with a first upper size limit defined based on a state of a second step of the plurality of steps;
storing a result of the determination process in a memory; and
in a third step of the plurality of steps, identifying the size of the first data with reference to the result stored in, the memory, and executing the specific process of the third step based on the identified size of the first data,
